(19) United States
(12) Patent Application Publication
(10) Pub. No.: US 2003/0136036 A1
(43) Pub. Date: Jul. 24, 2003

(54) Card device and method for making a card device

(76) Inventor: Leslie A. Zubli, Great Neck, NY (US)

Correspondence Address: Robert E. Bushnell, Suite 300, 1522 K Street, N.W., Washington, DC, 20005-1202, US

(21) Appl. No.: 10/050,555

(22) Filed: Jan. 18, 2002

(51) Int. Cl. G09F 1/00

(52) U.S. Cl. 40/124.15

(57) ABSTRACT

A card device with a clock and a business card attached to a flexibly joined unitary member, such as a single sheet of paper material, is provided. The card device includes a plurality of panels, fold lines on inside surface of the panels and score lines on a top surface of the panels. A clock and a battery assembly are attached to the inside surface of a panel, while visual display portions of the clock are exposed through openings of the panel on which the clock is positioned. The panels are folded along the fold lines to become disposed to an adjacent panel so as to be assembled to form a standing display, such as of a trigonal prism type shape standing display. A card, such as a business card, is positioned on a panel of the plurality of the panels and corners of the card are affixed in slots of the panel on which the card is positioned. The panels of the card device can be folded so as to provide a substantially flat arrangement in a closed position, so as to be placed in an envelope for sending to an individual.

### BACKGROUND OF THE INVENTION

1. Field of the Invention

The present invention pertains card devices, generally, and more specifically, to card devices having a business card and a clock attached to a flexibly joined unitary member, such as single sheet of a paper including flexibly joined panels.

2. Description of the Related Art

Card devices have been used in the past for displaying cards and calendars. Typically card devices are made of paper and hold various types of calendars and cards. With these conventional card devices, the assembly processes are typically very complicated and the assembled devices are not particularly suitable for business people. Furthermore items held by the card devices have been limited to calendars, note pads or picture cards, which are easily dislodged from the card device. I have found therefore there is a need to improve these conventional devices to provide a more compact and convenient card device for forming a standing display for a plurality of items, such as including a clock or time display, a personal greeting, or card such as a business card.

U.S. Pat. No. 5,280,961 for Pocket Calendar For Greeting or Note Cards issued to C. A. Rohloff, discloses a pocket calendar that includes a foldable paper blank. This patent discloses a paper blank forming a single sheet of paper cut with fold lines and score lines, that is preferably perforated. The paper blank serves three primary functions: a calendar mode, a pocket mode and a preferred mode. In the calendar mode, a front pocket panel is situated adjacent the second fold line and the first score line, and is adapted to fold on the second fold line to cover and be adhesively adhered to a back pocket panel. The calendar panel is situated adjacent the front pocket panel, the calendar panel being adapted for printing or otherwise affixing a calendar. In the pocket mode, the paper blank forms a pocket by folding the front panel along the second fold line to overlie the back pocket panel, whereby a card is affixed to the pocket. A portion of the calendar panel can be used for notes or the display of promotional items, such as business a card or coupons. Also, the calendar panel is provided with slots to temporarily affix the corners of the card to the calendar panel for the preferred mode. However, the assembling process for this pocket calendar is complicated. Moreover, this assembled calendar panel does not suggest the display of both a business card and a clock when it is placed on a flat surface, such as on a table. Furthermore, this patent does not suggest that a clock could be attached to a panel of a single sheet of paper and that a plurality of the panels of the single sheet of paper could form a display, such as a trigonal prism shape display, without being substantially deformed.

U.S. Pat. No. 5,782,357 for a Greeting Card and Retaining Tray Assembly, issued to K. D. Johnson discloses a greeting card device having a front panel and a rear panel connected along a fold line which allow the two panels to be movable relative to one another. The card device includes a pocket-forming housing or receptacle secured to an interior face of the panel. However, this patent suggests a complicated assembling process because several separate sheets of paper are needed to form the pocket-forming housing or the receptacle.

U.S. Pat. No. 4,997,126 for a Foldable and Sealable Greeting Card, issued to B. M. Amoss, discloses a foldable and sealable card having a series of panels connected by fold lines. Also, each panel includes illustrations and corresponding descriptions. Each panel is folded along a fold line to form the package. This patent, however, does not show a clock and business card attached on the panels of the single sheet of paper and that the folded paper can be formed to a trigonal prism shape, for example.

U.S. Pat. No. 4,709,493 for a Clock with Calendar Notepad, issued to C. E. Sapp discloses a clock with calendar notepad which includes a housing having a number of windows and a clock. A continuous roll of paper moves from a lower shaft toward an upper shaft. The shafts have an end section protruding from the housing. The shaft is connected to the clock. The paper roll has a sequential list of calendar dates. Several sets of labels can be readable in the windows. According to this patent, however, the assembling process of the components is complicated.

U.S. Des. Patent No. 263,124 for a Digital Clock Case, issued to R. E. Dennis discloses a digital clock installed on a surface of the prism-type clock case. U.S. Des. Patent No. 245,765 for a Clock, issued to Y.Yoshida discloses a clock on one surface of a pentagonal case. U.S. Des. Patent No. 264,821 for a Combined Clock and Desk Holder for Note Paper and Writing Instruments, issued to W. Henkela discloses the clock and desk holder for note paper and writing instruments. U.S. Des. Patent No. 277,556 for a Combined Clock and Paper Clip Holder, issued to C. J. Pappas, discloses a clock and paper clip holder installed in a case. These references show that a case including a clock using a rigid body and that a clock is installed on the rigid body of the case, using screws, separate covers or mold cases for forming a case. However, none of these designs illustrates a card device including a flexibly joined unitary member, such as a single sheet of paper with foldable panels, a clock and a business card.

Also, U.S. Pat. No. 5,435,085 for a Greeting Card Device issued to Johnson and U.S. Pat. No. 5,595,008 for a Greet Card Device issued to Johnson disclose a greeting card device including a pair of foldable panels and having an inner foldable receptacle capable of retaining water for retention of a living plant.

### SUMMARY OF THE INVENTION

It is an object of present invention to provide an improved card device for displaying a clock and a business card.

It is another object of the present invention to provide a card device for forming a standing display including a flexibly joined unitary member having foldable panels, such as formed of a single sheet of paper.

It is an yet another object of the present invention to provide a card device for forming a standing display having each panel folded along a fold line becoming disposed to the adjacent panel at approximately a 60 degree angle to form a trigonal prism shape which is not substantially deformed.

It is still yet a further object of the present invention to provide a card device for placing a business card on a top surface of first panel and affixing corners of the business card into slots of a first panel and to attach a clock on the inside surface of a second panel to expose visual display portions of the clock through openings of the panel.

It is another further object of the present invention to provide a card device for forming a standing display having the panels folded and positioned in a flat arrangement in a closed position to provide a folded card for insertion into an envelope.

To achieve these and other objects of the present invention, there is provided a card device including a flexibly joined unitary member, the flexibly joined unitary member including a plurality of joined panels for forming a standing display, wherein at least one of the plurality of joined panels is for receiving a clock and at least one of the plurality of joined panels is for receiving a card.

Additionally, the present invention preferably provides a card device including a paper material, such as a sheet of paper, having a plurality of flexibly joined of panels for forming a standing display, a clock positioned on one of the panels and a card, such a business card, positioned on the same panel as the clock or on a different one of the joined panels.

Also, the present invention also provides a process for making a card device including the steps of providing a flexibly joined unitary member, such as a sheet of a paper having a plurality of panels and fold lines between adjacent ones of the plurality of panels for forming a standing display, positioning a clock one of the panels, and positioning a card, such as business card, on the same panel as the clock or on a different one of the plurality of panels for displaying the clock and the card in the standing display.

Further, the present invention preferably provides a card device for inserting an arch type cut of one panel into a long perforation of another panel to maintain a trigonal shape and for concealing the arch type cut and the perforation by placing the business card on the top surface of the panel having the arch type cut of the card device.

Further yet, the present invention preferably provides a card device formed of a sheet of paper folded with top surfaces of a first panel, a second panel, and a third panel facing outward while top surfaces of a fourth panel and a fifth panel are, respectively, facing to the inside surface of the first panel and second panel during a folding operation to form a trigonal shape of the assembled card device for a standing display.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIGS. 1 and 2 are perspective views of a card device for displaying a clock and a card according to the present invention;

FIG. 3 shows an inside surface of a flexibly joined unitary member, such as of a paper material, used for forming a card device for displaying a clock and a card according to the practice of the present invention;

FIG. 4 shows a top surface of the flexibly joined unitary member of FIG. 3 according to the practice of the present invention;

FIG. 5 is an exploded, isometric view of a battery assembly for a clock according to the practice of the present invention;

FIG. 6 is a front view of a clock for display in a card device according to the practice of the invention;

FIG. 7 is a rear view of the clock of FIG. 6;

FIG. 8 shows card, such as a business card, for display in a card device according to the practice of the present invention;

FIG. 9 shows the clock and battery assembly attached to the inside surface of the flexibly joined unitary member of FIGS. 3 and 4 for forming a card device according to the present invention;

FIG. 10 shows the top surface of the flexibly joined unitary member of FIG. 9 used for forming a card device exposing visual display portions of the clock with the battery assembly being concealed according to the present invention;

FIG. 11 and FIG. 12 are partial cross-sectional views of a panel of the flexibly joined unitary member of FIGS. 3 and 4 and the clock positioned in the panel;

FIG. 13 shows an inside surface of a panel of the flexibly joined unitary member of FIGS. 3 and 4 holding a business card, according to the present invention;

FIG. 14 shows a top surface of the panel of FIG. 13 of the flexibly joined unitary member of FIGS. 3 and 4 having positioned thereon a card, such as a business card, according to the present invention;

FIGS. 15A through 15D are perspective views of steps of a folding operation for the flexibly joined unitary member of FIGS. 3 and 4 for forming a standing display according to the present invention;

FIG. 16 is a perspective view showing a folding operation for folding the panels of the flexibly joined unitary member of FIGS. 3 and 4 into a closed position to provide a flat assembly for a card device according to the present invention;

FIG. 17 is a perspective view showing the flat assembly of the card device of FIG. 16 for an enclosing operation of placing the card device in an envelope for sending the card device to an individual, such a customer;

FIG. 18 shows a perspective view of another embodiment of a card device according to the present invention;

FIG. 19 shows an alternative embodiment of a card device having a clock and card positioned on the same panel of the card device according to the present invention;

FIG. 20 shows another alternative embodiment of a card device having two panels for forming a standing display having a clock and a card positioned on the same panel according to the present invention;

FIGS. 21 and 22 shows another alternative embodiment of a card device having two panels for forming a standing display with a first one of the panels illustrated in FIG. 21 having a clock positioned thereon and the second one of the panels illustrated in FIG. 22 having a card positioned thereon according to the present invention;

FIG. 23 shows a perspective view of an embodiment of a card device of the present invention having a rectangular prism shape;

FIG. 24 shows a perspective view of an embodiment of a card device of the present invention having a pentagonal prism shape; and

FIG. 25 shows an embodiment of a flexibly joined unitary member used for forming a card device having a plurality of separate panels each flexibly joined by a joining member or fastener according to the present invention.

### DETAILED DESCRIPTION OF THE PREFERRED EMBODIMENTS

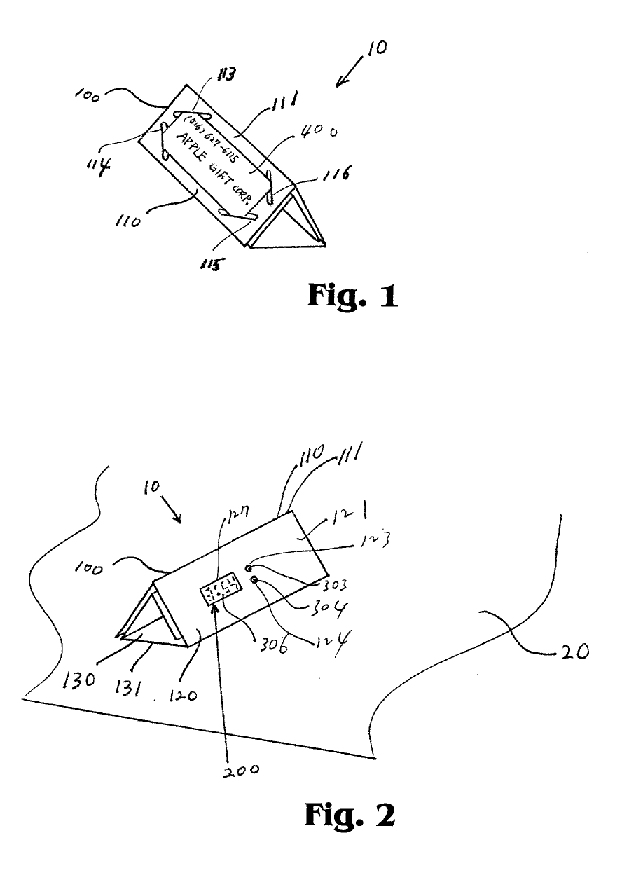

Referring to FIG. 1 and FIG. 2, FIGS. 1 and 2 are perspective views of an assembled card device 10 according to the present invention. The card device 10 includes a flexibly joined unitary member 100. The card device 10 is preferably formed of a paper material, such as a single sheet of paper, and also can be formed of any number of suitable materials, such as a card board paper material, a plastic material, a wood material and a metal material, for example, that are suitably flexibly joined to form the unitary member 100 for the card device 10. A business card 400 is placed on a top surface 111 of a first panel 110 of flexibly joined unitary member 100, such as single sheet of a paper, and is positioned on first panel 110 by being affixed into slots 113, 114, 115, 116 of the top surface 111 of first panel 110. Visual display portions 303, 304, 306 of a clock 200 are exposed through openings 123, 124, 127 of a second panel 120 of flexibly joined unitary member of 100 for positioning the clock 200 on the second panel 120.

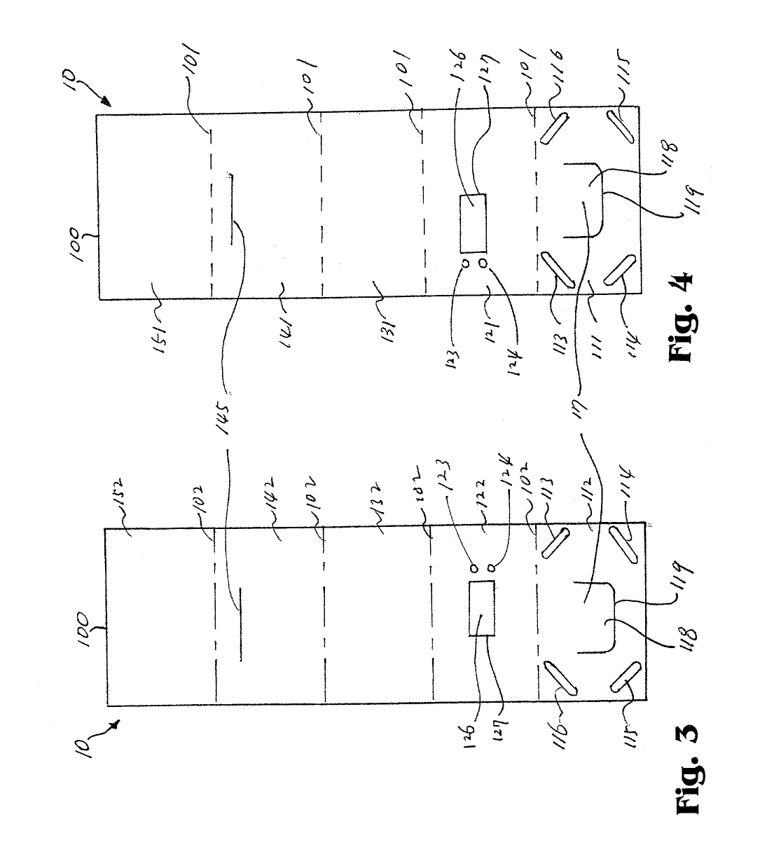

Continuing with reference to FIGS. 3 and 4, FIG. 3 shows inside surfaces of the flexible joined unitary member 100. The flexible joined unitary member 100 includes inside surfaces 112, 122,132,142, 152 of first through fifth of panels 110, 120, 130, 140, and 150 and fourfold lines 102 between adjacent panels. A long perforation 145 is formed on fourth panel 140. Second panel 120 has the openings 123, 124, and 127. First panel 110 includes slots 113, 114, 115, 116 and an arch type cut 117 having a cutout line 119 and a protruding portion 118. FIG. 4 shows outside surfaces or top surfaces 11, 121, 131, 141, 151 of the first through fifth panels 110, 120, 130, 140 and 150, respectively, of the flexibly joined unitary member 100 and four score lines 101 between adjacent panels.

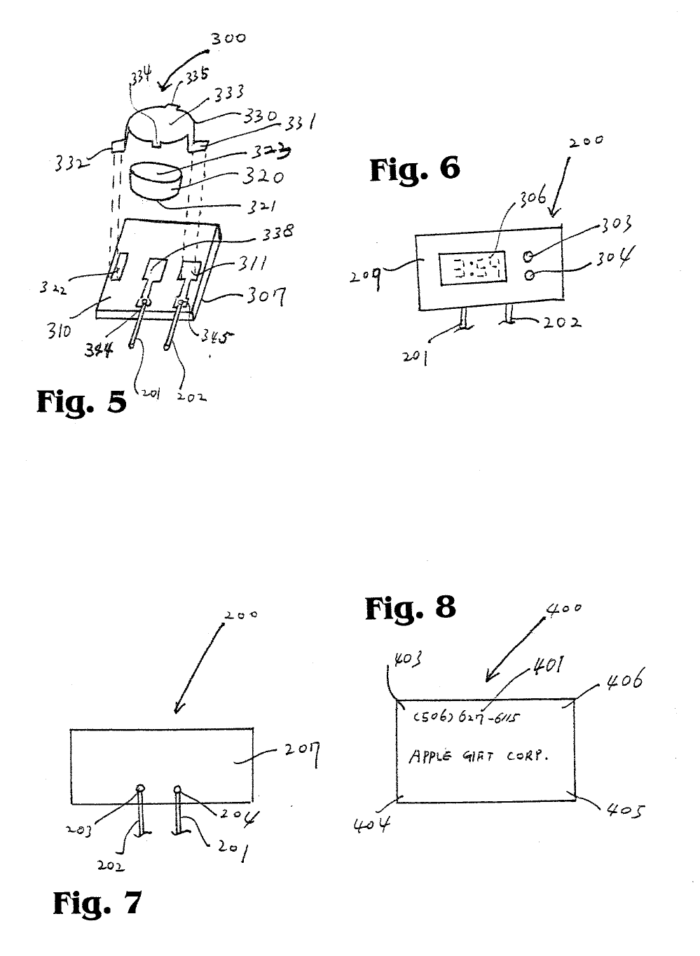

Referring to FIGS. 5, 6, 7 and 8, FIG. 5 illustrates an exploded, isometric view of a battery assembly 300 for clock 200 as can be used in a card device of the present invention. The battery assembly 300 includes a battery cover 333 that holds a battery 320 with first through fourth protrusions 331, 332, and 334, 335, respectively, and connects one electrode 323 of the battery 320 to first land 311, which is an electric land, on a printed circuit board 310 by soldering first protrusion 331 and the first electric land 311, and, by soldering second protrusion 332 and non-electric second land 322 for flexing the battery 320 in position. Third land 338, which is also an electric land, is connected to the other electrode 321 of the battery 320. The first land 331 is connected to first terminal 345 on the printed circuit board 310 and the third land 338 is connected to second terminal 344, first terminal 345 being connected to electric cord line 202 and second terminal 344 being connected to electric cord line 201 for connection to clock 200. FIG. 6 shows a front view of clock 200 for a card device of the present invention including a clock display 306, control buttons 303 and 304 and a front panel 209, as well as electric cord lines 201 and 202 from battery assembly 300. FIG. 7 shows a rear view of the clock 200 including a third terminal 203 and a fourth terminal 204 connected to the first terminal 345 and the second terminal 344 of the battery assembly 300 respectively by electric cord lines 202 and 201. Alternatively, the battery assembly 300 including printed circuit board 310 can be integrally formed with the clock 200 as a unitary structure to thereby shorten or eliminate the electric cord lines 201 and 202, for example. Further, while clock 200 is preferably a digital type clock, other suitable clocks or time displays can be used in the present invention, such as an analog type clock, for example.

FIG. 8 shows a card 400 for a card device of the present invention having four corners 403, 404, 405 and 406 which are affixed into the slots 113, 114, 115 and 116 of the first panel 110 to position card 400 on the first panel 110 of the flexibly joined unitary member 100 of card device 10 (FIGS. 3 and 4). The card 400 for a card device of the present invention, such as card device 10, preferably is a business card. The card 400 has an outer surface 401 having information, designs, etc. thereon positioned for outward display. However, the card 400 can also be any number of suitable card type items for positioning on the card device, such as a greeting card, a picture card, or a calender card, for example. Also, the card 400 can be of various shapes, such as rectangular, square, circular, pentagonal or hexagonal, for example, as well as can be formed various suitable materials or combination thereof, such as a paper material, such as a thin paper material or a card board paper material, a rubber material, wood or metal, for example.

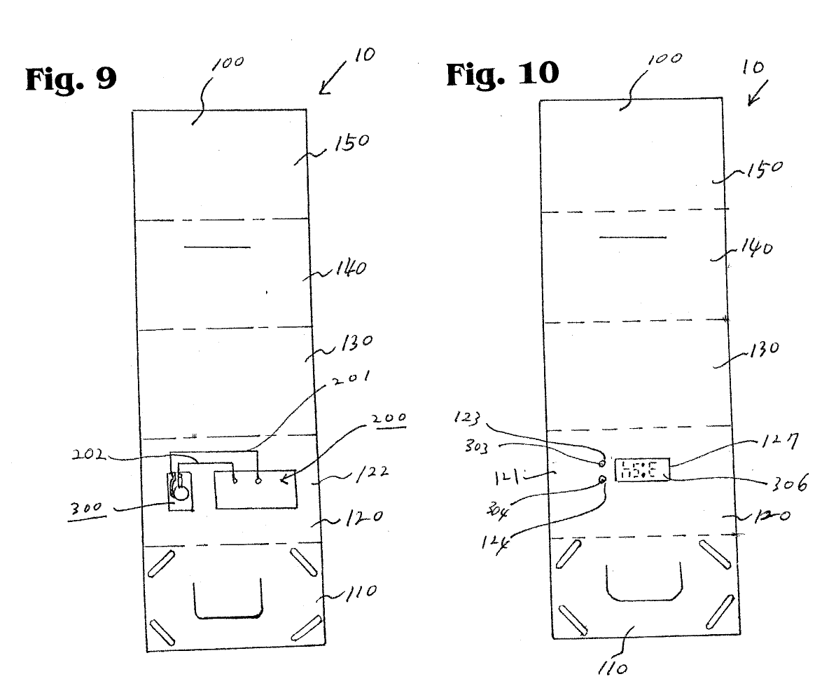

Referring now to FIGS. 9-14, these Figures illustrate an example of fixing or positioning of the card 400 and the clock 200 on the card device 10.

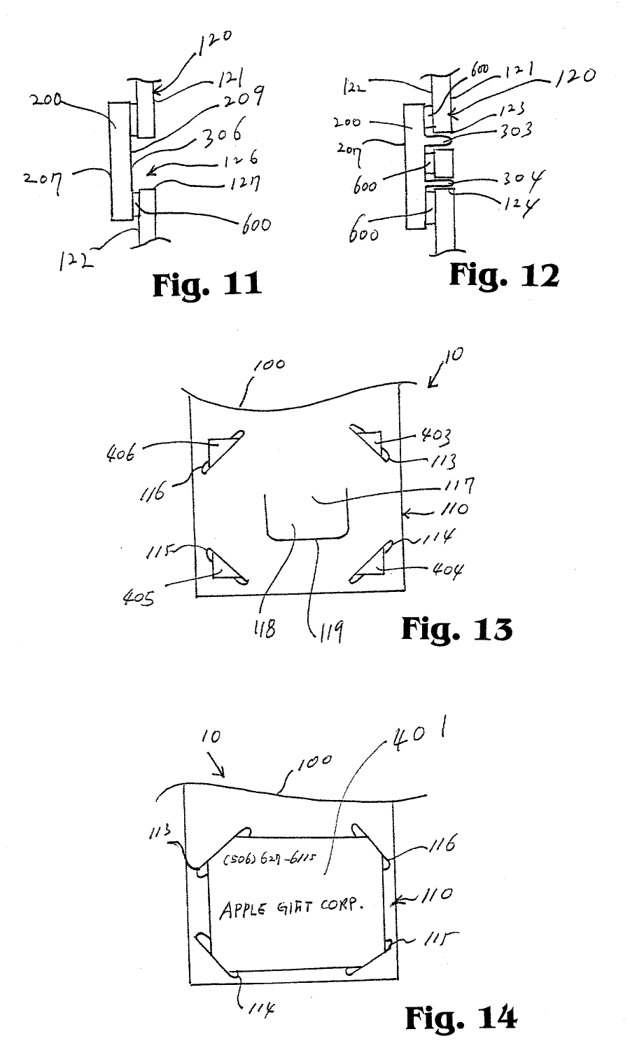

FIG. 9 illustrates an example of how the battery assembly 300 and the clock 200 are attached to the inside surface 122 of the second panel 120 of the flexibly joined unitary member 100 of card device 10. FIG. 10 shows visual portions 303, 304 and 306 exposed through the openings 127, 123 and 124 on the top surface 121 of the second panel 120 of the flexibly joined unitary member 100 of card device 10. FIG. 11 and FIG. 12 show partial cross-sectional views of an example of how the clock 200 is attached or positioned on the second panel 120. For example, glue 600 bonds the front panel 209 of the clock 200 to the inside surface 122 of the second panel 120 of the flexibly joined unitary member 100 of card device 10. The visual display portion 306 of clock 200 can be seen in a space 126 through the opening 127 in the second panel 120. The control buttons 303 and 304 of the clock 200 can be seen and are accessible through openings 123 and 124 in the second panel 120.

FIG. 13 and FIG. 14 illustrate an example of how a card 400 is positioned on or affixed to card device 10. FIG. 13 illustrates four corners 403, 404, 405 and 406 of the card 400, such as a business card, being affixed into the four slots 113, 114, 115 and 116 of the first panel 110 of the flexibly joined unitary member 100 of card device 10. FIG. 14 shows that the arch type cut 117 having the cut line 119 and the protruding portion 118 shown in FIG. 13 being concealed or hidden by the card 400. Alternatively, card 400 can be positioned on or affixed to a panel of the flexibly joined unitary member 100 of card device 10 by any suitable means, such as by glue or a fastener type arrangement, such as of Velcro®, for example. The battery assembly 300 and clock 200, except for the visual display portions 306,303 and 304, are concealed or hidden by the second panel 120 of the flexibly joined unitary member 100 of card device 10. Alternatively, the battery 320 can be installed in the clock 200 as a unitary structure, for example, as discussed previously.

Referring now to FIGS. 2, 3, 4, 15A through 15D, FIGS. 15A through 15D illustrate an example of how the panels of the card device 10 of the flexibly joined unitary member 100 are folded to form a standing display. First of all, it is preferable the clock 200 and battery assembly 300 are attached to the inside surface 122 of the second panel 120. The visual display portion 306 and the control buttons 303 and 304 are exposed through the openings 127, 123 and 124 of the second panel 120 (see FIG. 2). Second, the panels of the flexibly joined unitary member 100 of card device 10 are respectively folded along fold lines 102 (see FIG. 3) to become disposed to an adjacent panel preferably at approximately a 60 degree angle to be preferably assembled to form a trigonal prism type shape, for example. The inner side of clock 200 and of the battery assembly 300 are concealed as they are disposed between the inside surface 122 of the second panel 120 and the top surface 151 of the fifth panel 150.

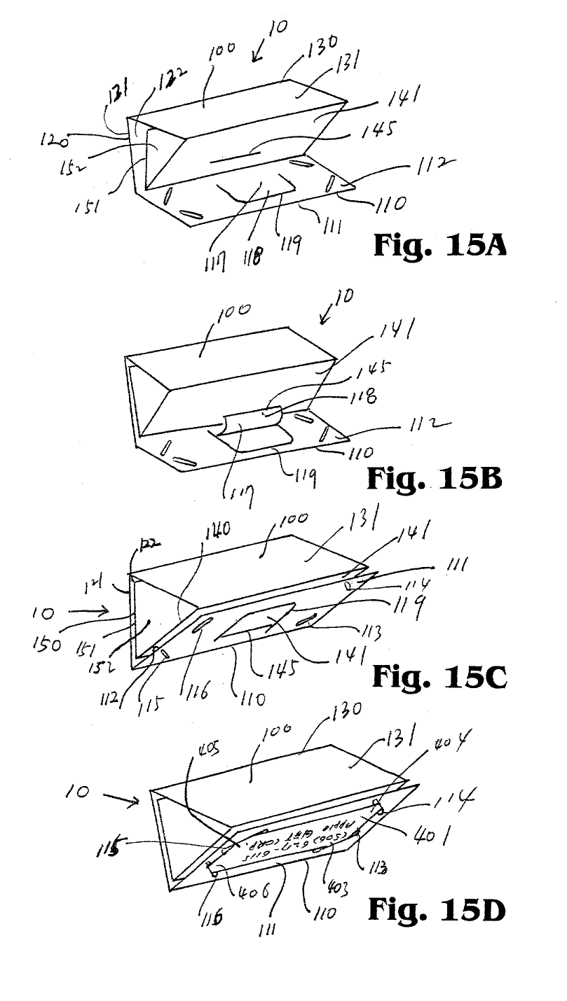

Continuing with reference to FIGS. 15A through 15D, thirdly, the protruding portion 118 of the arch-type cut 117 of the first panel 110 of the flexibly joined unitary member 100 of card device 10 is inserted into the perforation 145 of the fourth panel 140 of the flexibly joined unitary member 100 of card device 10. The perforation 145 and a partial portion of top surface 141 of the fourth panel 140 can be seen inside the area of the cutout line 119 while the first panel 110 is placed on the top surface 141 of the fourth panel 140. The flexibly joined unitary member 100 of card device 10 is folded as the top surfaces 111, 121 and 131 of the first panel 110, the second panel 120 and the third panel 130, respectively, are facing outward to form a trigonal prism type shape, while the top surfaces 141 and 151 of the fourth panel 140 and the fifth panel 150 are, respectively, facing to the inside surfaces 112 and 122 of the first panel 110 and the second panel 120 to form the assembled card device 10 during the folding operation to form a standing display. After the folding operation, the trigonal prism type shape of the standing display for card device 10 can withstand, for normal use, being substantially deformed or crushed.

Continuing with particular reference to FIGS. 2, 3, 4, 15C and 15D, as to a next step, card 400 such as a business card, is placed on the top surface 111 of the first panel 110. The four corners 403, 404, 405 and 406 of card 400 are affixed in slots 113, 114, 115 and 116 of the first panel 110 to position card 400 on the first panel 110. The perforation 145 and a partial surface of top surface 141 of the fourth panel 140 and the cutout line 119 of the first panel 110 are hidden or concealed by placing the card 400 on the top surface 111 of the first panel 110, to provide a simple and clear appearance of the assembled card device 10 for the standing display. The assembled card device 10 can now therefore serve as a convenient display of a business card and a clock when placed on a flat surface, such as on a table, by placing the top surface 131 of the third panel 130 of the trigonal prism type shape standing display on a surface 20, such as on a table, and by facing the top surfaces 111 and 121 of the first panel 110 and the second panel 120 in and outward direction, such as illustrated in FIG. 2, for example.

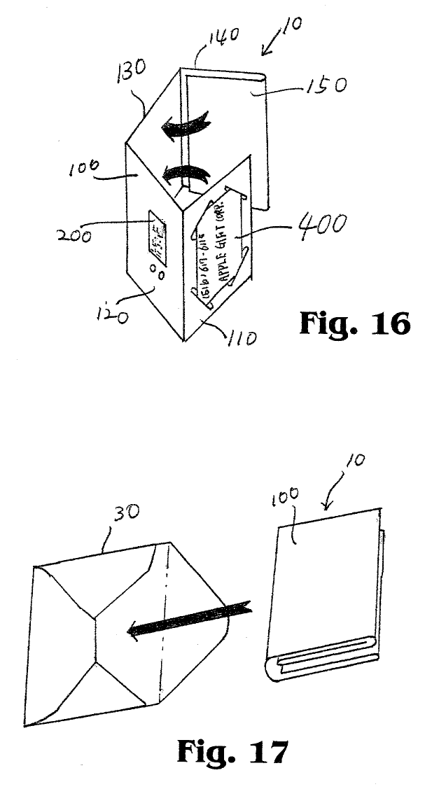

Referring now to FIGS. 16 and 17, FIG. 16 and FIG. 17 show an example of how a card device 10 can be folded into a substantially flat arrangement in a closed position for sending to an individual, such as a customer. FIG. 16 and FIG. 17 illustrate the panels 110, 120, 130, 140 and 150 of the flexibly joined unitary member 100 of card device 10 being substantially folded onto each other so as to lie in a flat arrangement in a closed position to serve as a folded card ready to be inserted into an envelope 30. The flat, folded arrangement for card device 10 in FIG. 17 provides a convenient way for business people to distribute the card device to customers or other business people for the purpose of an advertisement, with the customer arranging a card device 10 to form a standing display for the clock 200 and card 400 such as in a manner described above with respect to FIGS. 15A through 15D.

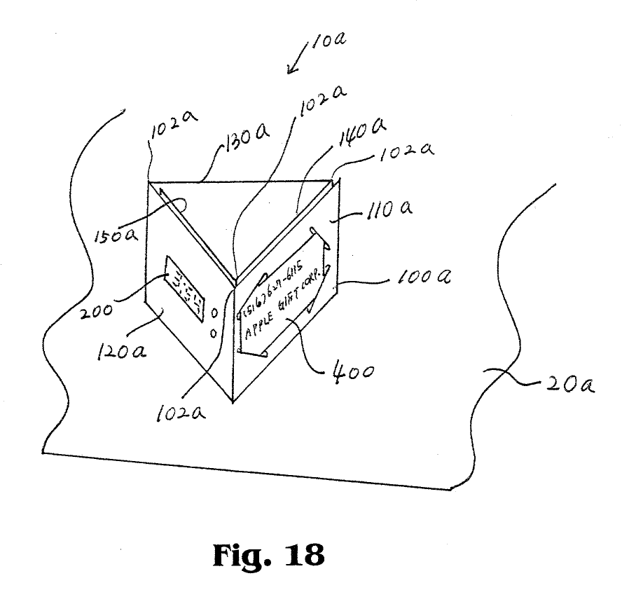

FIG. 18 illustrates a card device 10a according to another embodiment of the present invention. Card device 10a, similar to card device 10, has flexibly joined unitary member 100a having panels 110a, 120a, 130a, 140a and 150a. The clock 200 and business card 400 are respectively placed or positioned on the panels 110a and 120a, in a similar manner as on card device 10, vertically to the fold lines 102a. The surfaces of the panels form a 90-degree angle with the surface 20a, such as a table, while edges of the panels 110a, 120a, 130a, 140a and 150a contact the surface 20a.

Therefore, according to the principles of the present invention, a business card and clock can be placed on a panel or panels of the flexibly joined unitary member of a card device of the invention in any suitable direction, depending upon a desired configuration for a standing display arrangement of the card device.

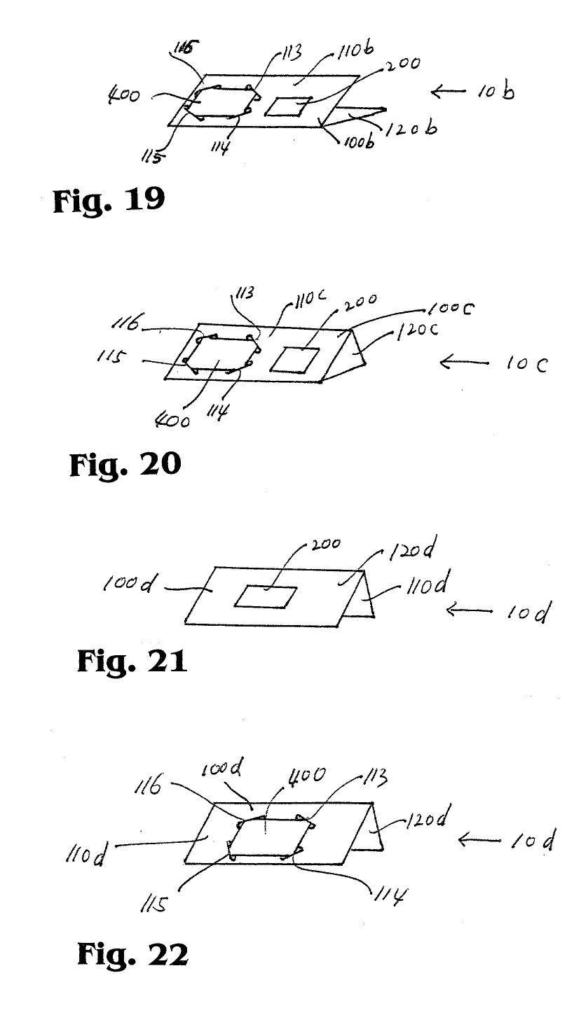

Referring now to FIG. 19, FIG. 19 illustrates a further embodiment of the present invention for a card device 10b. Card device 10b, similar to the card device 10, has a clock 200 and a card 400. However, the clock 200 and the clock 400 are affixed to or positioned on the same panel namely, first panel 10b of flexibly joined unitary member 100b of card device 10b. The flexibly joined unitary member 100b of card device 10b also has a second or base panel 120b. The second or base panel 120b is for placement on a surface, such as on a surface of a table, the standing display of the card device 10b thereby forming an angular type shape. The card 400 in card device 10b is positioned on or affixed to panel 110b by being inserted into the slots 113, 114, 115 and 116 in the panel 110b in a similar manner as on the card device 10. The clock 200 is positioned on panel 110b of flexibly joined unitary member 100b of card device 10b in a similar manner as on card device 10. Similar to the card device 10, the card device 10b can be folded into a closed position so as to provide a substantially flat arrangement in a closed position such as can be inserted in an envelope for providing to an individual, such as a customer.

FIG. 20 illustrates another embodiment of a card device 10c according to the present invention. Again, the card device 10c has a clock 200 and a card 400 both being positioned on the first panel 110c of flexibly joined unitary member 100c. The card device 10c also has a second panel 120c. As can be seen from the illustration and FIG. 20, the panels 110c and 120c form a tent-like triangular prism shape or inverted “V” shape arrangement for the standing display with the edges of the panels 110c and 120c contacting a display surface, such as the surface of a table. The card 400 in card device 10c is positioned on or affixed to panel 110c by being inserted into the slots 113, 114, 115 and 116 in the panel 110c in a similar manner as the card device 10. The clock 200 is positioned on panel 10c of card device 10c in a similar manner as on card device 10. Again, similar to the card device 10, the card device 10c can be folded in such a manner that the first panel 110c and the second panel 120c form a substantially flat arrangement, such as for placement in an envelope for sending to an individual, such as a customer.

FIGS. 21 and 22 illustrate an additional embodiment of the present invention for a card device 10d. The card device 10d has a flexibly joined unitary member 100d are having a first panel 110d and a second panel 120d which in a standing display form a tent-like trigonal prism type shape or an inverted “V’ shape, with the edges of the panels 110d and 120d contacting a surface, such as a surface of a table, to form a standing display. The card device 10d of FIGS. 21 and 22 are similar to the card device 10c of FIG. 20, except that the clock 200 is positioned on the panel 120d and the card 400 is positioned on the panel 110d. The card 400 in card device 10d is positioned on affixed to panel 110d by being inserted into the slots 113, 114, 115 and 116 in the panel 110d in a similar manner as on the card device 10. The clock 200 is positioned on panel 120d of flexibly joined unitary member 100d of card device 10d in a similar manner as on card device 10. Also, similar to the card device 10, the card device 10d illustrated in FIGS. 21 and 22 can be folded so that the panels 110d and 120d form a substantially flat arrangement in a closed position so as to be inserted into an envelope, such as for sending to a customer.

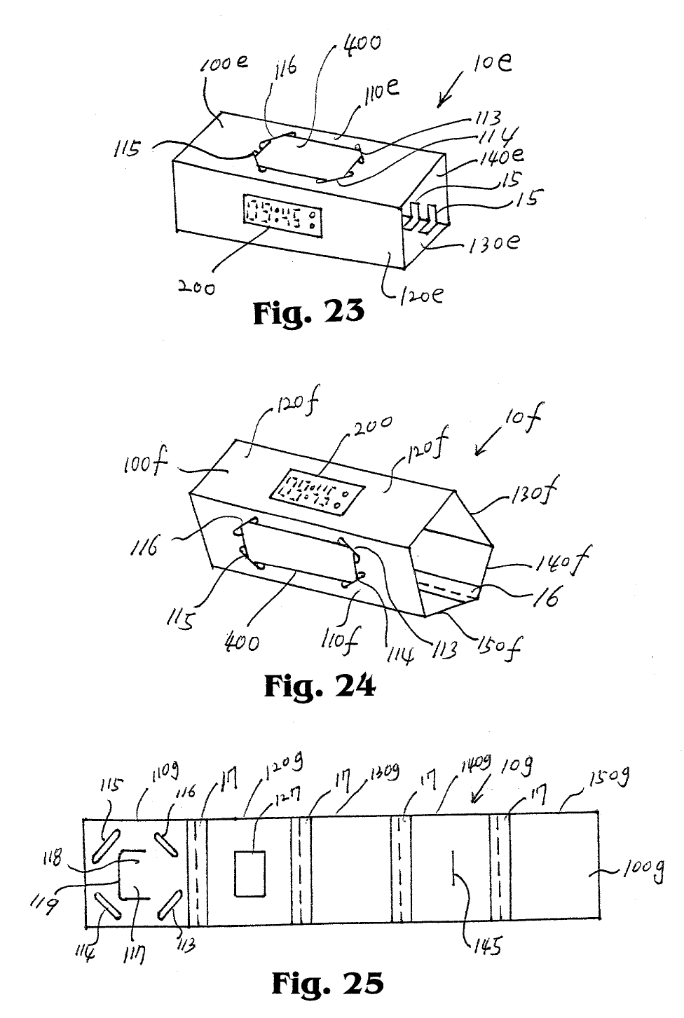

FIG. 23 illustrates another embodiment of a card device 10e according to the present invention having a generally rectangular prism type shape. The card device 10e has a flexibly joined unitary member 100e having a first panel 110e having the card 400 positioned thereon, a second panel 120e having the clock 200 positioned thereon, a third panel 130e and a fourth panel 140e. The card 400 is affixed to or positioned on the first panel 110e by being inserted into the respective slots, 113, 114, 115 and 116 in the first panel 10e. The clock 200 is positioned on panel 120e of flexibly joined unitary member 100e of card device 10e in a similar manner as on card device 10. The card device 10e is folded to form a standing display as illustrated in FIG. 23. However, an alternative arrangement to the arch type cut 117 having a cut out line 119 and a protruding portion 118 for insertion into the long perforation 145 of card device 10 is illustrated in card device 10e in FIG. 23. In card device 10e in FIG. 23, one or a plurality of individual fasteners 15 joining the third panel 130e and the fourth panel 140e are used in forming the standing rectangular prism type shape display for the card device 10e. The fasteners 15 can be any suitable fastener, such as an adhesive fastener, a snap type arrangement or a Velcro® type fastener arrangement, for example. As with the other embodiments of the present invention, the card device 10e, with the fastener or fasteners 15 being removed or disengaged, the panels 10e, 120e, 130e and 140e can be folded so as to form a substantially flat arrangement in a closed position to serve as a folded card inserted into an envelope, such as to be sent to an individual, such as a customer.

FIG. 24 illustrates another embodiment of a card device 10f according to the present invention. The card device 10f has a generally pentagonal prism type shape to form a standing display. The card device 10f has a flexibly joined unitary member 100f having a first panel 110f having positioned thereon the card 400. Card 400 is affixed to the first panel 110f by being inserted into a plurality of slots 113, 114, 115 and 116 in the first panel 110f. Flexibly joined unitary member 100f of card device 10f also includes a second panel 120f having positioned thereon a clock 200, a third panel 130f, a fourth panel 140f and a fifth panel 150f. The clock 200 is positioned on panel 120f of flexibly joined unitary member 100f of card device 10f in a similar manner as on card device 10. The panels 140f and 15 Of are joined together by another example of a fastener 16, the fastener 16 being a unitary type fastener extending lengthwise along and joining the panels 140f and 150f as illustrated in FIG. 24. The fastener 16 can be any suitable type, such as an adhesive type fastener or a Velcro® type fastener, for example. Other suitable fasteners can be used, such as the plurality of the fasteners 15 used in the card device 10e. Also, the card device 10f can be folded with the fastener 16, or other suitable type fastener, disengaged or removed, so as to provide a substantially flat arrangement in a closed position to serve as a folded card to be inserted into an envelope, such as an envelope 30 of FIG. 17, to be provided to an individual, such as a customer.

FIG. 25 illustrates a further example of the embodiment of a card device 10 g according to the present invention. Card device 10g is similar to the card device 10 of FIGS. 1-15D, with the exception that the panels 10g, 120g, 130g, 140g and 150g are each separate panels that are joined together by a fastener 17 to form the flexibly joined unitary member 100g of the card device 10g of the present invention. The fastener 17 illustrates in FIG. 25 is similar to the fastener 16 of FIG. 24, although a plurality of fasteners 15 as used in a card device 10e of FIG. 23 can be used for joining each of the adjacent ones of plurality of panels in the card device 10 g in FIG. 25, for example. Also, the fastener 17 joining adjacent panels of card device 10g can also be a hinge type assembly or arrangement, for example, to form a flexibly joined unitary structure. The card device 10g has in the panel 110g of flexibly joined unitary member 100g slots 113, 114, 115 and 116 into which can be inserted a card 400, and has an opening 127 in the panel 120g of flexibly joined unitary member 100g for positioning on the panel 120g a clock 200 in a similar manner to positioning clock 200 as on card device 10. The card device 10g in FIG. 25, similar to the card device 10, has the arch type cut 117 having a cut out line 119, a protruding portion 118 and a long perforation 145 to form a standing display for the card device 10g. The panels 110g, 120g, 130g, 140g and 150g in the card device 10g can be folded into a substantially flat arrangement in a closed position to serve as a folded card such as can be inserted into an envelope, such as envelope 30 in FIG. 17, such as can be provided to an individual, such as a customer.

Also, flexibly joined unitary members 100a, 10b, 100c, 10d, 10e, 100f and 100g of the various embodiments of the respective card devices 10a, 10b, 10c, 10d, 10e, 10f and 10g illustrated in FIGS. 18 through 25 can be formed of similar materials as discussed above with respective card device 10 are FIGS. 1-15D. Clock 200 and card 400 can likewise be similarly positioned on a panel or panels of the embodiment of the card device illustrated in FIGS. 18-25 in a similar manner to that discussed with the respect to card device 10 of FIGS. 1-15D. Also, the shapes, materials and construction of the clock 200 and card 400 can be similar to those previously discussed for the card 400 and clock 200 of card device 10 in FIGS. 1-15D.

While there have been illustrated and described what are considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation to the teaching of the present invention without departing from the scope thereof. Therefore, it is intended that the present invention not be limited to the particular embodiments disclosed as the best mode contemplated for carrying out the present invention, but that the present invention includes all embodiments falling within the scope of the appended claims.

What is claimed is:

1. A card device, comprising:
a member having a plurality of joined panels forming a flexible unitary structure, said plurality of joined panels for forming a standing display;
a clock positioned on one of said plurality of joined panels; and
a card positioned on one of said plurality of joined panels.

2. The card device as claimed in claim 1, wherein said member includes at least one fold line and at least one score line respectively between adjacent ones of said plurality of joined panels, wherein said at least one fold line is located on one surface of said member and said at least one score line is located on an opposing surface to said one surface of said member.

3. The card device as claimed in claim 2, wherein said plurality of joined panels are folded along said at least one fold line to become disposed to an adjacent one of said plurality of joined panels at approximately a 60 degree angle to form a trigonal type shape for said standing display.

4. The card device as claimed in claim 2, wherein one joined panel of said plurality of joined panels of said member includes a plurality of slots for positioning said card on said joined panel including said plurality of slots, and wherein at least one joined panel of said plurality of joined panels of said member includes at least one opening for positioning said clock on said joined panel including said at least one opening for said clock.

5. The card device as claimed in claim 4, wherein one joined panel of said plurality of joined panels includes a perforation and another joined panel of said plurality of joined panels includes a protruding portion, and wherein said protruding portion is inserted into said perforation to form said standing display.

6. The card device as claimed in claim 5, wherein in a closed position said member is folded so that said plurality of joined panels form a flat arrangement for said card device.

7. The card device as claimed in claim 1, wherein one joined panel of said plurality of joined panels of said member includes a plurality of slots for positioning said card on said joined panel including said plurality of slots, and wherein one joined panel of said plurality of joined panels includes at least one opening for positioning said clock on said joined panel including said at least one opening for said clock.

8. The card device as claimed in claim 7, wherein in a closed position said member is folded so that said plurality of joined panels form a flat arrangement for said card device.

9. The card device as claimed in claim 1, wherein in a closed position said member is folded so that said plurality of joined panels form a flat arrangement for said card device.

10. The card device as claimed in claim 1, wherein said plurality of joined panels comprises two panels and forms an angular shape for said standing display.

11. The card device as claimed in claim 1, wherein said plurality of joined panels comprises two panels and forms an inverted V tent-shape for said standing display.

12. The card device as claimed in claim 1, wherein said plurality of joined panels form a trigonal prism type shape for said standing display.

13. The card device as claimed in claim 1, wherein said plurality of joined panels form a rectangular prism type shape for said standing display.

14. The card device as claimed in claim 1, wherein said plurality of joined panels form a pentagonal prism type shape for said standing display.

15. The card device as claimed in claim 1, wherein said member comprises a paper material.

16. The card device as claimed in claim 15, wherein said plurality of joined panels are integrally formed of said paper material.

17. The card device as claimed in claim 1, wherein said plurality of joined panels are each separately formed and then joined to form said flexible unitary structure.

18. The card device as claimed in claim 1, wherein said plurality of joined panels are integrally formed as a unitary structure to provide said flexible unitary structure;

19. The card device as claimed in claim 1, wherein said clock and said card are each positioned on a same one of said plurality of joined panels.

20. The card device as claimed in claim 1, wherein said clock is positioned on one of said plurality of joined panels and said card is positioned on another one of said plurality of joined panels.

21. A card device, comprising:
a flexibly joined unitary member including a plurality of joined panels for forming a standing display, wherein at least one of said plurality of joined panels is for receiving a clock and at least one of said plurality of joined panels is for receiving a card.

22. A process for making a card device, comprising the steps of:
forming a flexibly joined unitary member including a plurality of joined panels as a unitary structure;
positioning a clock on one of said plurality of joined panels; and
positioning a card on one of said plurality of joined panels.

23. The process as claimed in claim 22, further comprising the step of positioning said plurality of joined panels so as to form a standing display for said card device.

24. The process as claimed in claim 23, wherein said standing display forms a trigonal type shape structure.

25. The process as claimed in claim 22, further comprising the step of positioning said plurality of joined panels in a closed position to form a flat arrangement for said card device.

26. The process as claimed in claim 25, further comprising the step of inserting said card device having said flat arrangement into an envelope.

27. The process as claimed in claim 26, further comprising the step of positioning said plurality of joined panels so as to form a standing display for said card device.

28. The process as claimed in claim 22, wherein said clock and said card are each positioned on a same one of said plurality of joined panels.

29. The process as claimed in claim 22, wherein said clock is positioned on one joined panel of said plurality of joined panels and said card is positioned on another joined panel of said plurality of joined panels.

30. The process as claimed in claim 22, wherein said plurality of joined panels of said flexibly joined unitary member are integrally formed as said unitary structure.

31. The process as claimed in claim 30, wherein said flexibly joined unitary member comprises a paper material.

32. The process claimed in claim 22, wherein said flexibly joined unitary member is formed of a plurality of separate panels with adjacent ones of plurality of separate panels joined to form said plurality of joined panels as said unitary structure.

33. The process as claimed in claim 32, wherein said flexibly joined unitary member comprises a paper material.

34. The process as claimed in claim 22, further comprising the steps of:
providing a plurality of slots on one joined panel of said plurality of joined panels for positioning said card on said joined panel having said plurality of slots; and
providing at least one opening on one joined panel of said plurality of joined panels for positioning said clock on said joined panel having said at least one opening for said clock.

35. The process as claimed in claim 34, further comprising the step of inserting a protruding portion in one joined panel of said plurality of joined panels into a perforation formed in another joined panel of said plurality of joined panels to form a standing display for said card device.

36. The process as claimed in claim 22, further comprising the step of inserting a protruding portion formed in one joined panel of said plurality of joined panels into a perforation formed in another joined panel of said plurality of joined panels to form a standing display for said card device.

37. A card device, comprising:
a member having a plurality of joined panels forming a flexible unitary structure, said plurality of joined panels for forming a standing display;
means for positioning a clock on one of said plurality of joined panels; and
means for positioning a card on one of said plurality of joined panels.

38. The card device as claimed in claim 37, wherein said means for positioning said card includes a plurality of slots for positioning said card and wherein said means for positioning said clock includes at least one opening for positioning said clock.

39. A process for making a card device, comprising the steps of:
forming a flexibly joined unitary member including a plurality of joined panels as a unitary structure;
providing means for positioning a clock on one of said plurality of joined panels; and
providing means for positioning a card on one of said plurality of joined panels.

40. The process as claimed in claim 39, further comprising the steps of:
providing as said means for positioning said card a plurality of slots on one joined panel of said plurality of joined panels for positioning said card on said joined panel having said plurality of slots; and
providing as said means for positioning said clock at least one opening on one joined panel of said plurality of joined panels for positioning said clock on said joined panel having said at least one opening for said clock.
